(19) United States
(12) Patent Application Publication
(10) Pub. No.: US 2025/0260656 A1
(43) Pub. Date: Aug. 14, 2025

(54) METHOD, COMPUTER DEVICE, AND NON-TRANSITORY COMPUTER-READABLE RECORDING MEDIUM TO CURATE CONTENT ON VARIOUS TOPICS USING CHATBOT

(71) Applicant: LINE Plus Corporation, Seongnam-si (KR)

(72) Inventor: Hongjoong SHIN, Seongnam-si (KR)

(73) Assignee: LINE Plus Corporation, Seongnam-si (KR)

(21) Appl. No.: 19/044,838

(22) Filed: Feb. 4, 2025

(30) Foreign Application Priority Data
Feb. 8, 2024 (KR) 10-2024-0019718

(51) Int. Cl. H04L 51/02

(52) U.S. Cl. CPC H04L 51/02

(57) ABSTRACT

Disclosed are a method, a computer device, and a non-transitory computer-readable recording medium for curing content on various topics through a chatbot. A content curation method may include creating recommended content for at least one topic using original content produced on at least one platform; providing the recommended content to a user using a chatbot for content curation; collecting a user response to the recommended content provided by the user to the chatbot; and reflecting the user response in at least one of a user's personalization recommendation and a report related to the recommended content.

### CROSS-REFERENCE TO RELATED APPLICATION(S)

This U.S. non-provisional application and claims the benefit of priority under 35 U.S.C. § 119 to Korean Patent Application No. 10-2024-0019718, filed Feb. 8, 2024, the entire contents of which are incorporated herein by reference in their entirety.

### BACKGROUND

### Technical Field

Some example embodiments relate to technology for providing recommended content.

### Related Art

Social media, such as a social network service (SNS) and a messenger, refers to services that aim at a person-to-person relationship, and supports interaction through posts by forming a relationship between users.

Social media may provide information to users in different contexts. For example, the social media may provide update information on a user's connections, post update information, content recommendation, and various other types of information items.

As the use of social media becomes more popular and more various functions are provided through a corresponding platform, a video platform capable of distributing and sharing short-form content produced as a short video of 15 seconds to 10 minutes or less is being serviced.

### SUMMARY

Some example embodiments may provide a content curation service that performs recommendation by classifying and summarizing latest content produced on various platforms by topic using generative artificial intelligence (AI).

Some example embodiments may randomly select a topic for a user that adds a chatbot for content curation as a friend and may recommend summary content of the selected topic.

Some example embodiments may collect user responses to recommended content by conversing with a user having read the recommended content and may reflect the same in next recommendation.

Some example embodiments may provide a reward and a report based on user response by including information on a creator in recommendation of content.

Some example embodiments of inventive concepts provide a content curation method implemented on a computer device including at least one processor, the content curation method including creating, by the at least one processor, recommended content for at least one topic using original content produced on at least one platform; providing, by the at least one processor, the recommended content to a user using a chatbot for content curation; collecting, by the at least one processor, a user response to the recommended content provided by the user to the chatbot; and reflecting, by the at least one processor, the user response in at least one of a user's personalization recommendation and a report related to the recommended content.

Some example embodiments of inventive concepts provide a computer device including at least one processor configured to execute computer-readable instructions on the computer device to cause the at least one processor to create recommended content for at least one topic using original content produced on at least one platform, provide the recommended content to a user using a chatbot for content curation, collect a user response to the recommended content provided by the user to the chatbot, and to reflect the user response in at least one of a user's personalization recommendation and a report related to the recommended content.

Further areas of applicability will become apparent from the description provided herein. The description and example embodiments in this summary are intended for purposes of illustration only and are not intended to limit the scope of the present inventive concepts.

### BRIEF DESCRIPTION OF DRAWINGS

FIG. 1 is a diagram illustrating an example of a network environment according to some example embodiments;

FIG. 2 is a diagram illustrating an example of a computer device according to some example embodiments;

FIG. 3 is a flowchart illustrating an example of a method that may be performed by a computer device according to some example embodiments;

FIGS. 4 to 6 illustrate examples of original content on a topic in some example embodiments;

FIG. 7 illustrates an example of results of summarizing original content of a topic in some example embodiments;

FIG. 8 illustrates an example of recommended content created based on content summary in some example embodiments;

FIG. 9 illustrates an example of delivery of recommended content in some example embodiments;

FIGS. 10 to 11 illustrate examples of user interaction on recommended content in some example embodiments;

FIG. 12 illustrates an example of user personalization information in some example embodiments; and

FIG. 13 illustrates an example of a statistical report on recommended content in some example embodiments.

### DETAILED DESCRIPTION

One or more example embodiments will be described in detail with reference to the accompanying drawings. Example embodiments, however, may be embodied in various different forms, and should not be construed as being limited to only the illustrated example embodiments. Rather, the illustrated example embodiments are provided as examples so that this disclosure will be thorough and complete, and will fully convey the present inventive concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

As used herein, the singular forms “a,” “an,” and “the,” are intended to include the plural forms as well, unless the context clearly indicates otherwise. It will be further understood that the terms “includes,” “comprises,” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “one or more of” and/or “at least one of,” when preceding a list of elements, modify the entire list of elements and do not modify the individual elements of the list. Also, the term “exemplary” is intended to refer to an example or illustration.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Hereinafter, some example embodiments will be described with reference to the accompanying drawings.

The example embodiments relate to technology for providing recommended content.

Example embodiments including disclosures disclosed herein may classify and summarize content produced on various platforms by topic and then, recommend summary content of a topic randomly selected through a chatbot, thereby eliminating bias in content consumption and providing an environment in which a user may access content on a more variety of topics.

A content curation system according to some example embodiments may be implemented by at least one computer device, and a content curation method according to some example embodiments may be performed through at least one computer device included in a content curation system. A computer program according to some example embodiments may be installed and run on the computer device, and the computer device may perform the content curation method according to example embodiments under control of the computer program. The aforementioned computer program may be stored in a computer-readable record medium (or in a non-transitory computer-readable storage medium) to implement the content curation method in conjunction with the computer device.

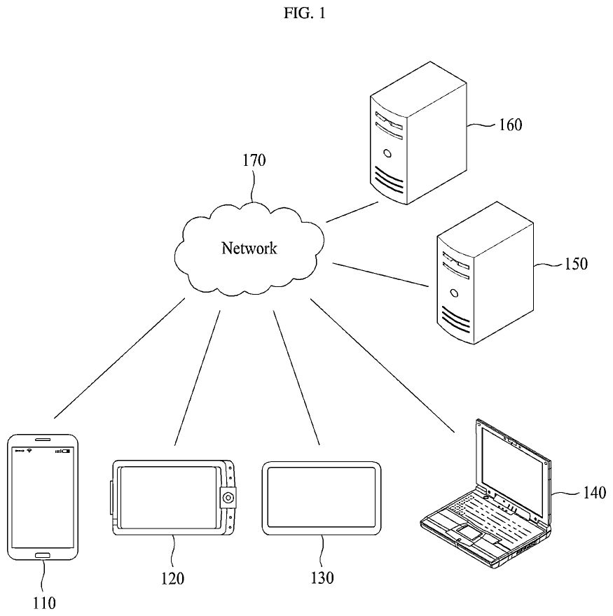

FIG. 1 illustrates an example of a network environment according to some example embodiments. Referring to FIG. 1, the network environment may include a plurality of electronic devices 110, 120, 130, and 140, a plurality of servers 150 and 160, and a network 170. FIG. 1 is provided as an example only, and example embodiments are not limited thereto. The number of electronic devices or the number of servers is not limited thereto. Also, the network environment of FIG. 1 is provided as one example of environments applicable to the example embodiments and an environment applicable to the example embodiments is not limited to the network environment of FIG. 1.

Each of the plurality of electronic devices 110, 120, 130, and 140 may be a fixed terminal or a mobile terminal that is configured as a computer device. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet PC, and the like, but example embodiments are not limited thereto. For example, although FIG. 1 illustrates a shape of a smartphone as an example of the electronic device 110, the electronic device 110 used herein may refer to one of various types of physical computer devices capable of communicating with other electronic devices 120, 130, and 140, and/or the servers 150 and 160 over the network 170 in a wireless or wired communication manner.

The communication scheme is not limited and may include a near field wireless communication scheme between devices as well as a communication scheme using a communication network (e.g., a mobile communication network, wired Internet, wireless Internet, and a broadcasting network) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and the Internet, but example embodiments are not limited thereto. Also, the network 170 may include at least one of network topologies that include a bus network, a star network, a ring network, a mesh network, a star-bus network, a tree or hierarchical network, and the like. However, they are provided as examples only, and example embodiments are not limited thereto.

Each of the servers 150 and 160 may be configured as a computer device or a plurality of computer devices that provides an instruction, a code, a file, content, a service, etc., through communication with the plurality of electronic devices 110, 120, 130, and 140 over the network 170. For example, the server 150 may be a system that provides a service (e.g., content curation service) to the plurality of electronic devices 110, 120, 130, and 140 connected over the network 170.

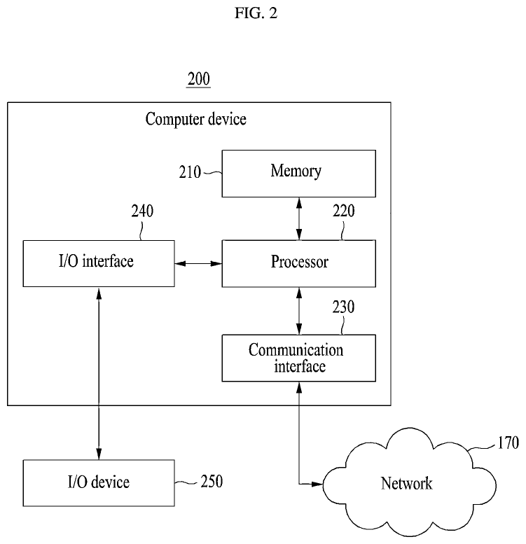

FIG. 2 is a block diagram illustrating an example of a computer device according to some example embodiments. Each of the plurality of electronic devices 110, 120, 130, and 140 or each of the servers 150 and 160 may be implemented by a computer device 200 of FIG. 2.

Referring to FIG. 2, the computer device 200 may include a memory 210, a processor 220, a communication interface 230, and an input/output (I/O) interface 240. The memory 210 may include a permanent mass storage device, such as a random access memory (RAM), a read only memory (ROM), and a disk drive, as a non-transitory computer-readable record medium (or a non-transitory computer-readable storage medium). The permanent mass storage device, such as ROM and a disk drive, may be included in the computer device 200 as a permanent storage device separate from the memory 210. Also, an OS and at least one program code may be stored in the memory 210. Such software components may be loaded to the memory 210 from another non-transitory computer-readable record medium separate from the memory 210. The other non-transitory computer-readable record medium may include a non-transitory computer-readable record medium, for example, a floppy drive, a disk, a tape, a DVD/CD-ROM drive, a memory card, etc. According to some example embodiments, software components may be loaded to the memory 210 through the communication interface 230, instead of the non-transitory computer-readable record medium. For example, the software components may be loaded to the memory 210 of the computer device 200 based on a computer program installed by files received over the network 170. The processor 220 may be configured to process instructions of a computer program by performing basic arithmetic operations, logic operations, and I/O operations. The computer-readable instructions may be provided by the memory 210 or the communication interface 230 to the processor 220. For example, the processor 220 may be configured to execute received instructions in response to a program code stored in a storage device, such as the memory 210.

The communication interface 230 may provide a function for communication between the communication apparatus 200 and another apparatus, for example, the aforementioned storage devices, over the network 170. For example, the processor 220 of the computer device 200 may forward a request or an instruction created based on a program code stored in the storage device such as the memory 210, data, and a file, to other apparatuses over the network 170 under control of the communication interface 230. In some example embodiments, a signal, an instruction, data, a file, etc., from another apparatus may be received at the computer device 200 through the communication interface 230 of the computer device 200. A signal, an instruction, data, etc., received through the communication interface 230 may be forwarded to the processor 220 or the memory 210, and a file, etc., may be stored in a storage medium, for example, the permanent storage device, further includable in the computer device 200.

The I/O interface 240 may be a device used for interfacing with an I/O device 250. For example, an input device may include a device, such as a microphone, a keyboard, a mouse, etc., and an output device may include a device, such as a display, a speaker, etc. As another example, the I/O interface 240 may be a device for interfacing with an apparatus in which an input function and an output function are integrated into a single function, such as a touchscreen, but example embodiments are not limited thereto. The I/O device 250 may be configured as a single apparatus with the computer device 200.

Also, according to some example embodiments, the computer device 200 may include a greater or smaller number of components than the number of components of FIG. 2. However, there is no need to clearly illustrate most conventional components. For example, the computer device 200 may be configured to include at least a portion of the I/O device 250 or may further include other components, such as a transceiver and a database.

Hereinafter, example embodiments of a method and a device for curating content on various topics through a chatbot are described.

The computer device 200 according to some example embodiments may provide a client with a content curation service through a dedicated application installed on the client or through connection to a website/mobile site related to the computer device 200. A computer-implemented content curation system may be configured in the computer device 200. For example, the content curation system may be implemented in a form of a program that independently operates or may be configured in an in-app form of a specific application to be operable on the specific application.

The processor 220 of the computer device 200 may be implemented as a component to perform the following content curation method. In some example embodiments, the components of the processor 220 may be selectively included in or excluded from the processor 220. Also, in some example embodiments, the components of the processor 220 may be separated or merged for functional expression of the processor 220.

The processor 220 and the components of the processor 220 may control the computer device 200 to perform operations included in the following content curation method. For example, the processor 220 and the components of the processor 220 may be implemented to execute an instruction according to a code of at least one program and a code of an operating system (OS) included in the memory 210.

The components of the processor 220 may be expressions of different functions performed by the processor 220 in response to an instruction provided from a program code stored in the computer device 200.

The processor 220 may read an instruction (or a necessary instruction) from the memory 210 to which instructions related to control of the computer device 200 are loaded. In some example embodiments, the read instruction may include an instruction to control the processor 220 to perform the following operations.

The operations included in the content curation method described below may be performed in order different from the illustrated order, and a portion of operations may be omitted or an additional process may be further included.

The operations included in the content curation method may be performed by the server 150. In some example embodiments, at least a portion of the operations may be performed by the client.

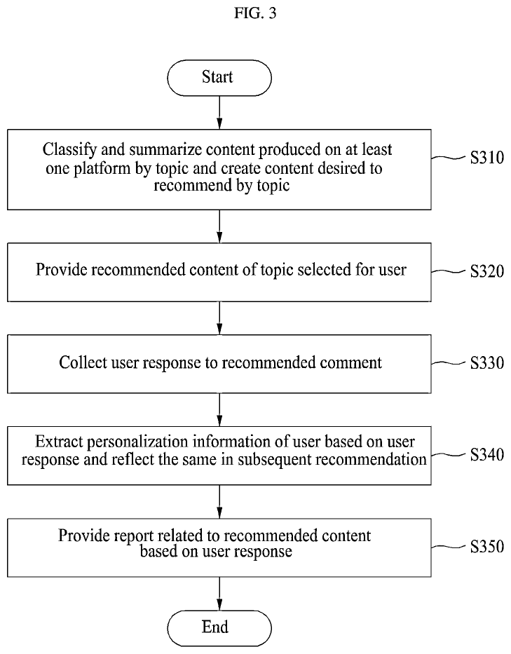

FIG. 3 is a flowchart illustrating an example of a method that may be performed by a computer device according to some example embodiments.

Referring to FIG. 3, in operation S310, the processor 220 may classify and summarize content produced on at least one platform by topic (hereinafter, ‘original content’) and may create content desired to recommend by topic (hereinafter, ‘recommended content’). The processor 220 may create the recommended content by topic using the original content posted in a public on a social media platform or other platforms linked to social media. In this specification, social media may inclusively indicate an integrated media platform that provides various types of services using resources such as profile information and friend relationship of a user within a social network service in addition to the social network service such as a messenger or various types of communities. For example, the processor 220 may integrate content produced over a recent period of time (e.g., 24 hours) on various platforms, such as a video service implemented on the server 150, an openchat function of a messenger, and a news service, and may classify and summarize the content by topic. In some example embodiments, the processor 220 may classify original content recently provided through a plurality of platforms by topic using at least one of the already disclosed document classification technologies. The processor 220 may summarize the recent content classified by topic using generative AI, such as a chat generative pre-trained transformer (GPT) and then may create the recommended content based on corresponding summary. In some example embodiments, the processor 220 may record reference information indicating original content that is used for content summary and creation, for example, a source in association with the recommended content. The reference information may include information on a link of the original content and a creator of the corresponding content.

In operation S320, the processor 220 may provide the recommended content to a user that adds a dedicated chatbot for content curation (hereinafter, ‘curator bot’) as a friend. For example, the processor 220 may provide recommended content of a topic selected for the user from among the recommended content created by topic through various approaches, such as a report method and conversation using the curator bot. The processor 220 may randomly select a topic to access various topics and may provide recommended content of the selected topic. In some example embodiments, may also provide recommended content of a topic selected based on user preference. In some example embodiments, when providing the recommended content, the processor 220 may also provide reference information including information on original content that is a source of the recommended content, for example, creator information of the original content.

In operation S330, the processor 220 may collect user response to the recommended content. The processor 220 may perform interaction with the user using the curator bot and may collect the user response to the recommended content through interaction between the curator bot and the user. For example, the processor 220 may attempt conversation with the user at a point in time at which a certain period of time elapses after providing the recommended content to the user, and may collect user feedback, such as ratings, surveys, and subscription intention for the recommended content itself or the topic of the recommended content, through a related query of the recommended content.

In operation S340, the processor 220 may extract the user's personalization information based on the user response and may reflect the same in subsequent recommendation. To recommend content to the user, the processor 220 may verify personalization information, such as preference, interest, and subscription status for the recommended content itself or the topic of the recommended content from interaction data between the curator bot and the user.

In operation S350, the processor 220 may provide a report related to the recommended content based on the user response. For example, the processor 220 may provide an effect report, including information such as an increase or a decrease in the number of content views or followers by users that are introduced through the recommended content, to a creator of the original content that is a source of the recommended content. As another example, the processor 220 may provide a statistical report including information that compiles user responses to the recommended content by topic, to help the creator produce content in response to a request from the creator. In some example embodiments, the report (e.g., the effect report and/or the statistical report) may be generated and provided by the processor 220 to the creator and/or a user, and may transmit (or send, or upload) the report to a database, cloud storage, secure server, or the like, for the report to be saved in a non-transitory computer readable storage medium and/or any other non-transitory storage medium. In some example embodiments, the processor 220 may be configured to instruct an image forming device, such as a printer or other output device, to print a physical copy of the report. In some example embodiments, the processor 220 may be configured to compress, watermark, or encrypt the report to ensure it meets specific security standards before uploading it to an online system, such as a database, cloud storage, secure server, or the like.

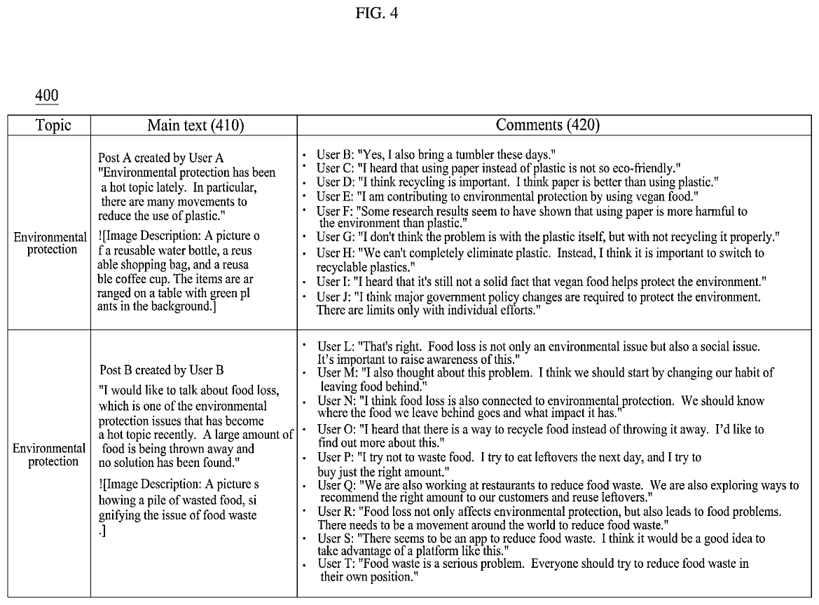

FIGS. 4 to 6 illustrate examples of original content on a topic in some example embodiments.

FIGS. 4 to 6 illustrate examples of original content classified under the topic of “environmental protection.”

Referring to FIG. 4, the processor 220 may perform topic classification according to content of a main text 410 by targeting posts 400 set to public view among posts created by users on a platform that shares various types of posts, such as texts, images, and videos between users. The posts created by users may be recent posts (e.g., posts created within one day), but example embodiments are not limited thereto. The content classification may include a text, an image, and a video that may be included in the main text 410. Reactions, for example, comments 420 of users having the read the posts 400 may be used with content summary of a topic to which the posts 400 belongs. The processor 220 may record reference information including link and creator information of the posts 400 that is original data used to summarize content by topic and may use the same for future follow-up or notification.

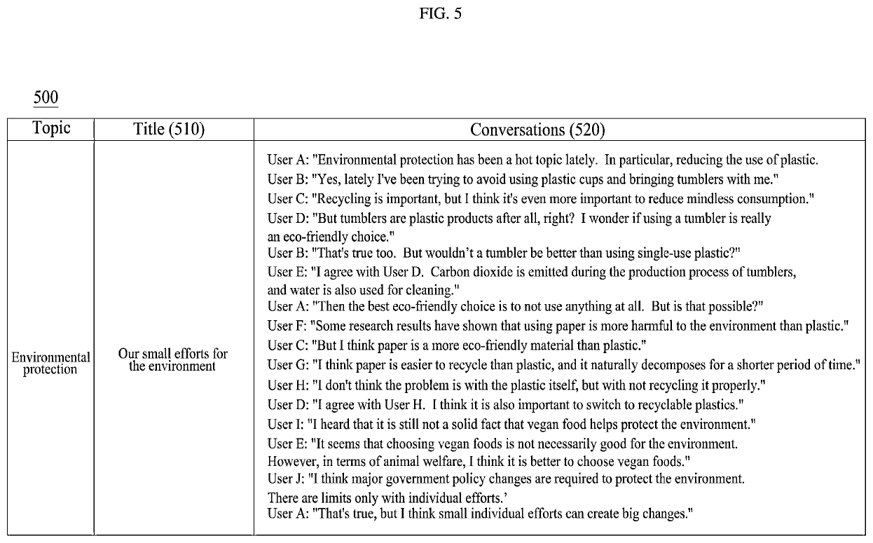

Referring to FIG. 5, the processor 220 may classify topics based on a title 510 and conversations 520 of a chatroom 500 with respect to the chatroom 500 that is operated through messenger openchat. Since a matter of interest in openchat may vary depending on a period (e.g., a period of time), the conversations 520 exchanged within a set period may be summarized. In some example embodiments, in the case of openchat, anonymous conversations 520 (or only anonymous conversations 520) may be summarized and a link of the openchat chatroom 500 used for content summary by topic may be recorded as the reference information.

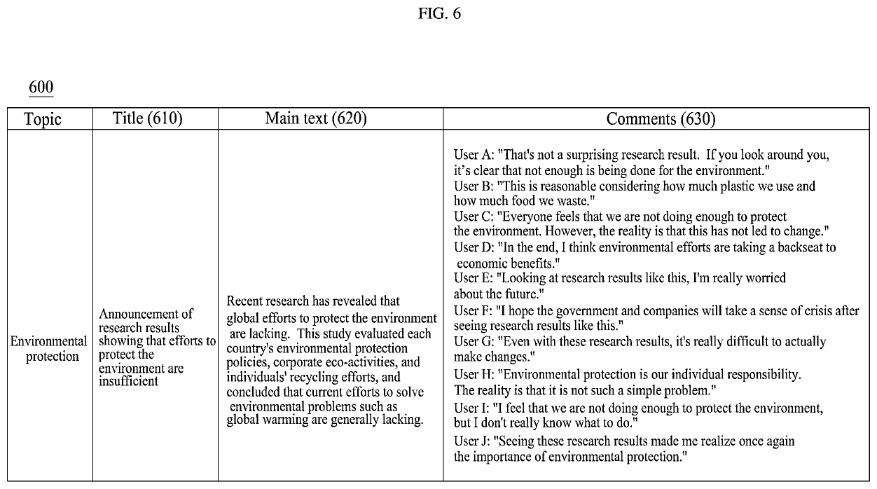

Referring to FIG. 6, the processor 220 may classify topics based on a title 610 and a main text 620 of news 600 with respect to the news 600 recently published (e.g., within approximately one day) on a news platform. In the case of the news 600, a text, an image, and a video that may be included in the main text 620 may be included in content classification. Reactions, for example, comments 630 of users having read the news 600 may be used with content summary of a topic to which the news 600 belongs. Reference information including link and author information of the news 600 that is original data used for content summary by topic may be recorded.

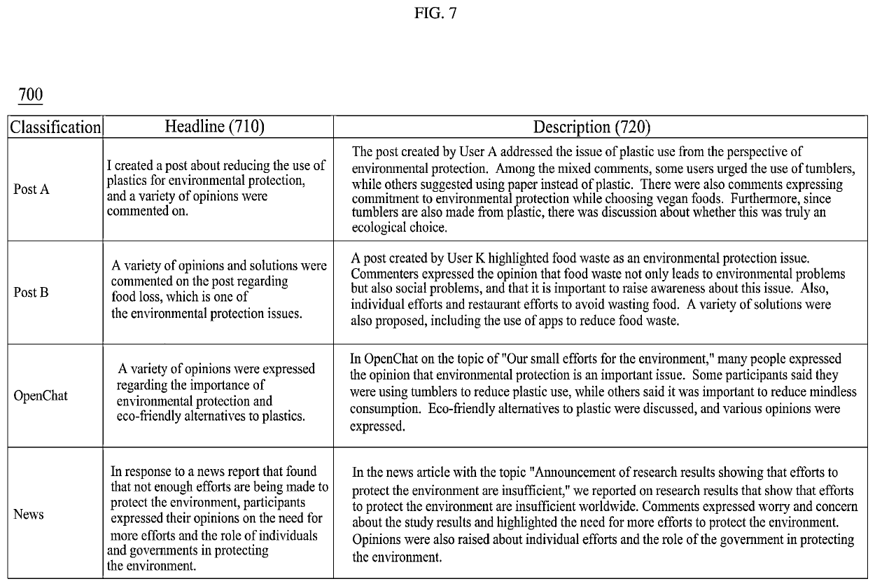

Results of summarizing the original content, for example, the posts 400, the openchat chatroom 500, and the news 600 classified under the topic of ‘environmental protection’ of FIGS. 4 to 6 are shown in FIG. 7. A content summary 700 may include a headline 710 and a description 720 for each original content.

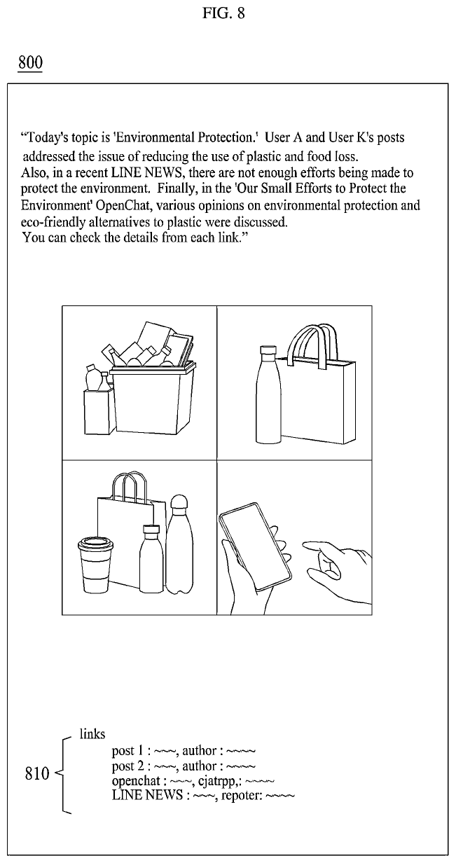

FIG. 8 illustrates an example of recommended content created based on content summary in some example embodiments.

The processor 220 may create recommended content for each topic based on summary of original content classified by topic. For example, the processor 220 may summarize original content created in approximately the past day on various platforms, such as a video service, a messenger openchat, and a news service, on the topic ‘environmental protection’ and then, may use the summarized content to write a post 800 on the topic of ‘environmental protection’ as shown in FIG. 8. The recommended content may be created in a form of the post 800 that is displayed on a video service platform. Each post 800 written as the recommended content may include content such as text, an image, and a video extracted from original content and may also include content, such as text, an image, and a video created by generative AI based on the summary. Also, when creating the post 800, the post 800 may include reference information 810 including link and creator information of the original content that is a source of the post 800.

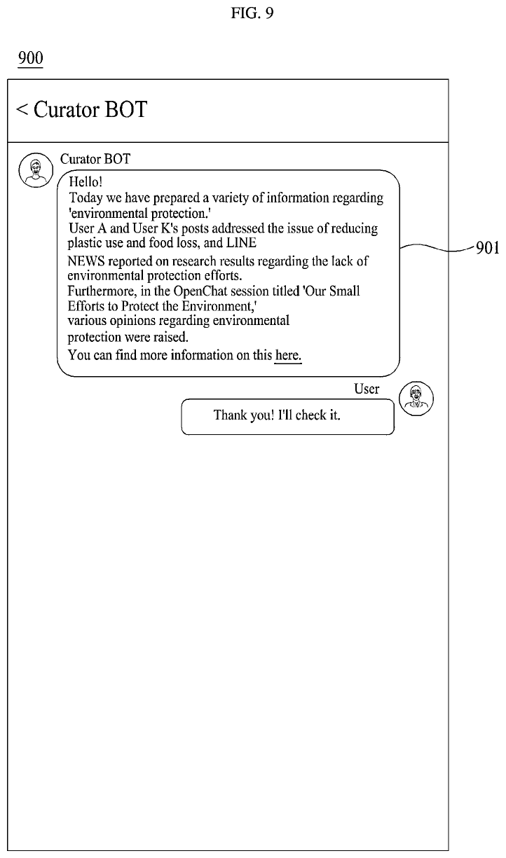

FIG. 9 illustrates an example of delivery of recommended content in some example embodiments.

The processor 220 may provide recommended content of a randomly selected topic among recommended content by topic through a chatroom in which a curator bot and a user participate, with respect to the user that adds the curator bot as a friend of a messenger. Referring to FIG. 9, the processor 220 may display a guidance message 901 about the recommended content of the randomly selected topic in the form of a chat message from the curator bot through a chatroom 900 with the curator bot. The guidance message 901 may include a link capable of verifying the recommended content. For example, the guidance message 901 may include the link of the post 800 written as the recommended content and brief description related to the topic of the post 800. In some example embodiments, when the user selects the link included in the guidance message 901, the user may be directed to a service screen on which the post 800 of FIG. 8 is displayed.

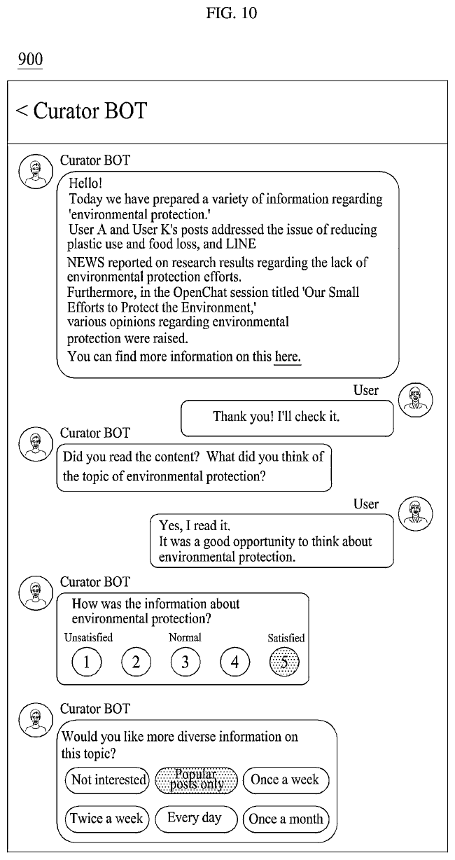

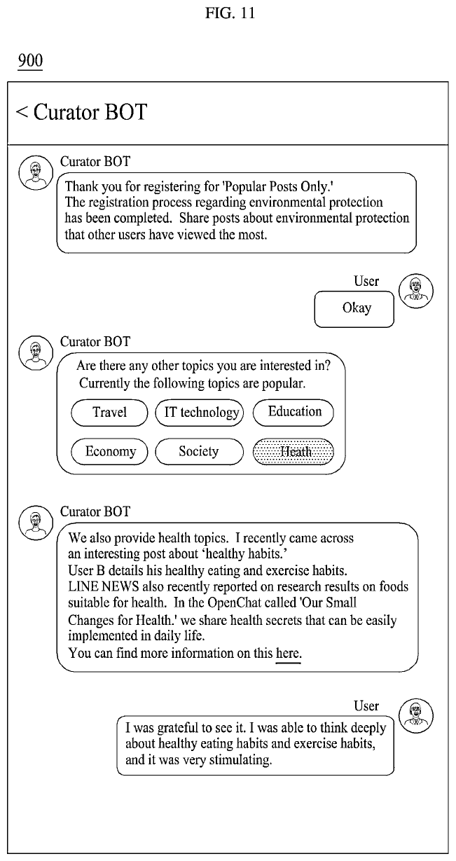

FIGS. 10 to 11 illustrate examples of user interaction on recommended content in some example embodiments.

In some example embodiments, when the user reads the recommended content provided through the curator bot, for example, when the user selects the link included in the guidance message 901, the processor 220 may determine that the recommended content is read and may attempt conversation with the user to collect user response to the recommended content after a certain period of time elapses from the corresponding point in time. Referring to FIG. 10, when the user reads the recommended content, the processor 220 may collect user feedback, such as a rating, a survey, and subscription intention for the recommended content through the chatroom 900 with the curator bot.

Meanwhile, referring to FIG. 11, when the user does not read the recommended content provided through the curator bot, the processor 220 may collect feedback for a topic preferred by the user through the chatroom 900 with the curator bot. For example, the processor 220 may provide, as options, remaining topics excluding the topic not read by the user among topics of which recommended content is created and may receive a selection on a topic in which the user is interested. If there is recommended content that is delivered but not read, the processor 220 may recommend the user to read the same through a reminder and may verify reaction and reason according thereto and may reflect the same in subsequent recommendation.

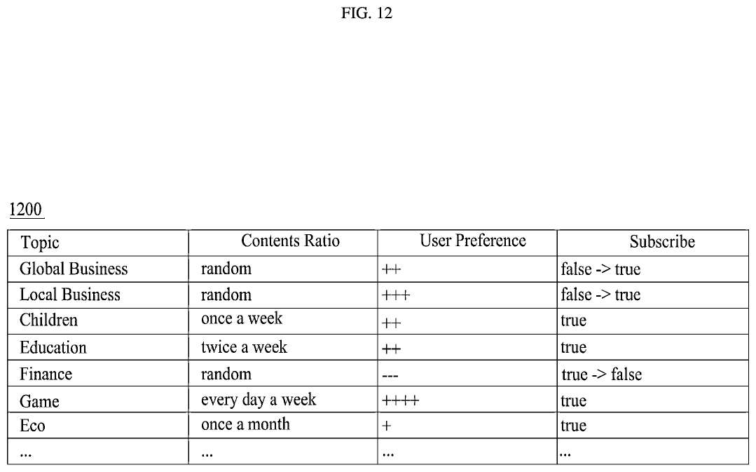

FIG. 12 illustrates an example of user personalization information in some example embodiments.

The processor 220 may collect user responses to the recommended content through conversation between the curator bot and the user, and may extract personalization information of the user based thereon. Referring to FIG. 12, the processor 220 may collect the user response to the recommended content and may build personalization information 1200, such as a ratio at which the user receives recommended content by topic, degree of preference by topic, and subscription status, and may reflect the personalization information 1200 of the user in subsequent recommendation. For example, the processor 220 may provide recommendation based on a topic to which the user subscribes or a topic preferred by the user by conversing with the curator bot, and may exclude a topic to which subscription the user has cancelled from the recommendation. The processor 220 may provide content of a topic desired to recommend based on the user's subscription settings or preference by conversing with the curator bot, or may provide content on various topics through random recommendation regardless of the subscription settings or the preference, for a certain percentage within a certain period. In addition to the preference or the subscription status, the processor 220 may designate a time or the number of times to receive recommended content by conversing with the curator bot and may also apply the recommended content to be delivered under user-specified condition.

The processor 220 may provide additional functions, such as summarizing conversations exchanged with the user on the recommended content by conversing with the curator bot and then reflecting summary content in the recommended content or sharing the same in an openchat chatroom. For example, in the case of the recommended content created from recent conversations in openchat, the processor 220 may summarize conversations exchanged between the curator bot and users on the corresponding content and may share the same in the corresponding openchat.

When recommending content, the processor 220 may provide a reward to a creator of original content related to the recommended content, including reference information that is a source. Also, the processor 220 may provide an effect report, such as an increase or a decrease in the number of content views or followers by users introduced through the recommended content, using a method such as a notification, to the creator of the original content that is a source of the recommended content.

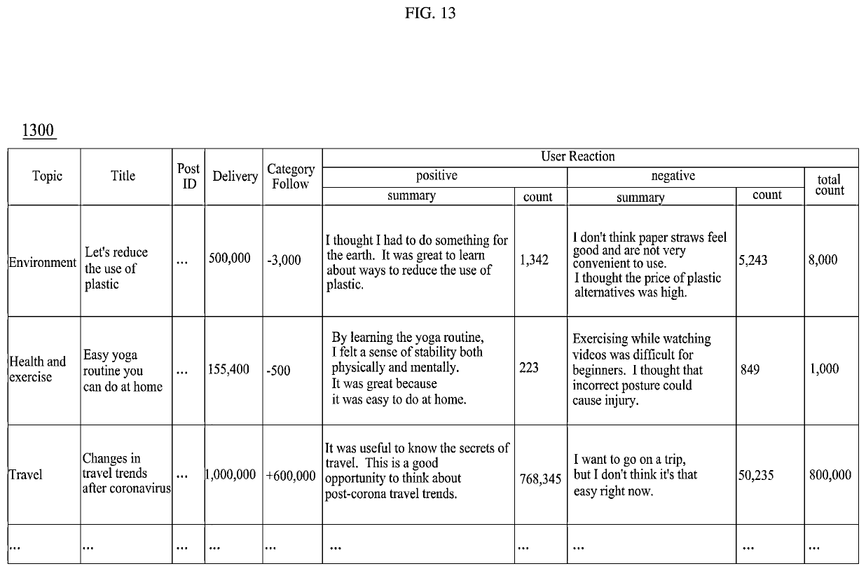

The processor 220 may provide a statistical report that compiles user responses to the recommended content by topic to help the creator produce content. For example, referring to FIG. 13, a statistical report 1300 of recommended content by topic may include information on the number of times the recommended content is delivered, information on an increase or a decrease in the number of followers by users introduced through the recommended content, information on the number of times the recommended content is read, and positive response and negative response to the recommended content. The processor 220 may classify conversations exchanged with users regarding the recommended content into positive content and negative content using emotion analysis by conversing with the curator bot and then, may summarize each of the positive content and the negative content and include the same in the statistical report 1300.

As described above, according to some example embodiments, it is possible to provide content curation that classifies and summarizes latest content produced on various platforms by topic using generative AI, thereby improving a user's content consumption experience, promoting community activation by strengthening connection between a creator and the user, and increasing service revenues through targeting using personalization information acquired from user response.

The apparatuses described above may be implemented using hardware components, software components, and/or combination thereof. For example, the apparatuses and components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For simplicity, the description of the processing device is used as singular; however, one skilled in the art will be appreciated that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, virtual equipment, a computer storage medium or device, or in a propagated signal wave capable of providing instructions or data to or being interpreted by the processing device. The software also may be distributed over network coupled computer devices so that the software is stored and executed in a distributed fashion. The software and data may be stored by one or more computer readable storage mediums (or non-transitory computer-readable storage mediums).

The methods according to some example embodiments may be configured in a form of program instructions performed through various computer methods and recorded in non-transitory computer-readable media. Here, the media may continuously store computer-executable programs or may temporarily store the same for execution or download. Also, the media may be various types of recording devices or storage devices in a form in which one or a plurality of hardware components are combined. Without being limited to media directly connected to a computer system, the media may be distributed over the network. Examples of the media may include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Examples of other media may include recording media and storage media managed by an app store that distributes applications or a site, a server, and the like that supplies and distributes other various types of software.

One or more functional blocks and/or elements shown in the figures and described above may be implemented in processing circuitry such as hardware including logic circuits, a hardware/software combination such as a processor executing software, or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

While this disclosure includes some example embodiments, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents. Therefore, other implementations, other example embodiments, and equivalents are within the scope of the following claims.

What is claimed is:

1. A content curation method implemented on a computer device including at least one processor, the content curation method comprising:
creating, by the at least one processor, recommended content for at least one topic using original content produced on at least one platform;
providing, by the at least one processor, the recommended content to a user using a chatbot for content curation;
collecting, by the at least one processor, a user response to the recommended content provided by the user to the chatbot; and
reflecting, by the at least one processor, the user response in at least one of a user's personalization recommendation and a report related to the recommended content.

2. The content curation method of claim 1, wherein the creating comprises classifying the original content by topic and creating the recommended content for each topic.

3. The content curation method of claim 1, wherein the creating comprises:
classifying the original content by topic; and
creating the recommended content by summarizing the original content classified by topic using generative artificial intelligence (AI).

4. The content curation method of claim 1, wherein
the creating comprises creating the recommended content using the original content, and
the original content was produced over a recent period of time on the at least one platform.

5. The content curation method of claim 1, wherein
the providing of the recommended content comprises providing reference information indicating the original content, and
the original content is a source of the recommended content.

6. The content curation method of claim 5, wherein the reference information includes information on at least one of a link and a creator of the original content.

7. The content curation method of claim 1, wherein the recommended content is randomly selected for the user from among one or more recommended contents classified by topic.

8. The content curation method of claim 1, wherein the collecting comprises, when it is determined that the user read the recommended content, collecting the user response to the recommended content through a conversation between the chatbot and the user after a certain period of time elapses from a corresponding point in time.

9. The content curation method of claim 1, wherein the reflecting comprises extracting a user's personalization information for content recommendation based on the user response.

10. The content curation method of claim 9, wherein the user's personalization information includes at least one of preference by topic and a subscription status.

11. The content curation method of claim 1, wherein the reflecting comprises providing an effect report by a user to a creator of the original content that is a source of the recommended content.

12. The content curation method of claim 1, wherein the reflecting comprises providing a statistical report that compiles user responses to the recommended content by topic to a creator of the original content.

13. The content curation method of claim 12, wherein the statistical report includes a summary of positive content and negative content among conversations exchanged with users about the recommended content.

14. The content curation method of claim 1, further comprising:
sharing, by the at least one processor, the user response through an openchat related to the recommended content,
wherein the sharing includes, when the recommended content is created based on recent conversations of the openchat, summarizing conversations exchanged with users about the content, and sharing the summarized conversations on the openchat.

15. A non-transitory computer-readable recording medium storing instructions that, when executed by a processor, cause the processor to perform the content curation method of claim 1.

16. A computer device comprising:
at least one processor configured to execute computer-readable instructions on the computer device to cause the at least one processor to,
create recommended content for at least one topic using original content produced on at least one platform,
provide the recommended content to a user using a chatbot for content curation,
collect a user response to the recommended content provided by the user to the chatbot, and
reflect the user response in at least one of a user's personalization recommendation and a report related to the recommended content.

17. The computer device of claim 16, wherein the at least one processor is further caused to classify the original content by topic and create the recommended content by summarizing the original content classified by topic using generative artificial intelligence (AI).

18. The computer device of claim 16, wherein
the at least one processor is caused to provide reference information indicating that the original content is a source of the recommended content, and
the reference information includes information on at least one of a link and a creator of the original content.

19. The computer device of claim 16, wherein
the at least one processor is caused to extract a user's personalization information for content recommendation based on the user response, and
the user's personalization information includes at least one of preference by topic and a subscription status.

20. The computer device of claim 16, wherein the at least one processor is caused to provide at least one of an effect report by a user and a statistical report that compiles user responses to the recommended content by topic to a creator of the original content.
